(19) United States
(12) Patent Application Publication
(10) Pub. No.: US 2026/0370768 A1
(43) Pub. Date: Nov. 19, 2026

(54) IMAGE FORMING APPARATUS, METHOD, AND NON-TRANSITORY RECORDING MEDIUM

(71) Applicant: Fumiyuki HEISHI, Kanagawa (JP)

(72) Inventor: Fumiyuki HEISHI, Kanagawa (JP)

(73) Assignee: ETRIA CO., LTD., Yokohama-shi (JP)

(21) Appl. No.: 19/652,460

(22) Filed: Apr. 20, 2026

(30) Foreign Application Priority Data
May 16, 2025 (JP) 2025-082944

(51) Int. Cl. H04N 1/387; G06T 3/60; G06T 7/00; G06T 7/33; H04N 1/00; H04N 1/23

(52) U.S. Cl. CPC H04N 1/3877; G06T 3/60; G06T 7/0004; G06T 7/33; H04N 1/00809; H04N 1/00816; H04N 1/2323; G06T 2207/30144; H04N 2201/0094

(57) ABSTRACT

In an image forming apparatus, the reader reads the document, at the reading position, in a scanning direction parallel to a first axis and orthogonal to the conveyance direction to output a two-dimensional image data including a first document image having a first edge. The circuitry rotates the first document image to align the first edge, being tilted at a first tilt relative to a first axis, to be parallel with the first axis to generate a second document image having a second edge, being tilted at a second tilt, different from the first tilt, relative to a second axis orthogonal to the first axis; and output adjustment information including the second tilt relative to the second axis. The adjustor adjusts an orientation of the conveyor or the reader, based on the adjustment information. The image former forms an image based on the second document image.

### CROSS-REFERENCE TO RELATED APPLICATIONS

This patent application is based on and claims priority pursuant to 35 U.S.C. § 119(a) to Japanese Patent Application No. 2025-082944, filed on May 16, 2025, in the Japan Patent Office, the entire disclosure of which is hereby incorporated by reference herein.

### BACKGROUND

### Technical Field

The present disclosure relates to an image forming apparatus, a method, and a non-transitory recording medium.

### Related Art

An image forming apparatus has been developed that includes a document feeder, a document reader, and an image forming device. The document feeder is a discrete unit retrofittable to a main unit of the image forming apparatus.

### SUMMARY

The present disclosure described herein provides an image forming apparatus including a conveyor, a reader, circuitry, an adjuster, and an image former. The conveyor conveys a document to a reading position in a conveyance direction. The reader reads the document, at the reading position, in a scanning direction parallel to a first axis and orthogonal to the conveyance direction to output a two-dimensional image data including a first document image having a first edge. The circuitry rotates the first document image to align the first edge, being tilted at a first tilt relative to a first axis, to be parallel with the first axis to generate a second document image having a second edge, being tilted at a second tilt, different from the first tilt, relative to a second axis orthogonal to the first axis; and output adjustment information including the second tilt relative to the second axis. The adjustor adjusts an orientation of the conveyor or the reader, based on the adjustment information. The image former forms an image based on the second document image.

The present disclosure described herein provides a method including conveying a document to a reading position in a conveyance direction by a conveyor; reading the document by a reader, at the reading position, in a scanning direction parallel to a first axis and orthogonal to the conveyance direction to output a two-dimensional image data including a first document image having a first edge; rotating the first document image to align the first edge, being tilted at a first tilt relative to a first axis, to be parallel with the first axis to generate a second document image having a second edge, being tilted at a second tilt, different from the first tilt, relative to a second axis orthogonal to the first axis; outputting adjustment information including the second tilt relative to the second axis; adjusting an orientation of the conveyor or the reader, based on the adjustment information; and forming an image based on the second document image.

The present disclosure described herein provides a non-transitory recording medium storing a plurality of instructions which, when executed by one or more processors, causes the one or more processors to perform a method including conveying a document to a reading position in a conveyance direction by a conveyor; reading the document by a reader, at the reading position, in a scanning direction parallel to a first axis and orthogonal to the conveyance direction to output a two-dimensional image data including a first document image having a first edge; rotating the first document image to align the first edge, being tilted at a first tilt relative to a first axis, to be parallel with the first axis to generate a second document image having a second edge, being tilted at a second tilt, different from the first tilt, relative to a second axis orthogonal to the first axis; outputting adjustment information including the second tilt relative to the second axis; adjusting an orientation of the conveyor or the reader, based on the adjustment information; and forming an image based on the second document image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an image forming apparatus;

FIG. 2 is a schematic view of an image reader of the image forming apparatus illustrated in FIG. 1, illustrating an automatic document feeder and an image reading device;

FIGS. 3A and 3B are schematic views of an adjustment unit provided for a hinge;

FIG. 4 is a schematic view of internal components of an image forming apparatus;

FIG. 5 is a detailed view of internal components of an automatic document feeder;

FIG. 6 is a detailed view of internal components of an image reading device;

FIG. 7 is a schematic diagram of a hardware configuration of an image forming apparatus;

FIG. 8 is a schematic diagram illustrating a configuration of functional blocks of a controller;

FIG. 9 is a flowchart illustrating a method for an inspection process;

FIGS. 10A, 10B, 10C, and 10D are schematic diagrams illustrating a tilt of a document image caused by a tilt of a document itself;

FIGS. 11A, 11B, 11C, and 11D are schematic diagrams illustrating a tilt of a document image caused by a tilt of an automatic document feeder itself;

FIGS. 12A and 12B are schematic diagrams illustrating two other cases in which a document image results in a parallelogram shape;

FIG. 13 is a diagram illustrating a document used for inspection;

FIGS. 14A and 14B are schematic diagrams illustrating a scanned image obtained by scanning an inspection document;

FIG. 15 is a schematic diagram illustrating an adjustment direction of the orientation of an automatic document feeder in the case illustrated in FIGS. 14A and 14B;

FIGS. 16A and 16B are schematic diagrams illustrating a counterclockwise rotation of a document image;

FIG. 17 is a schematic diagram illustrating an adjustment direction of the orientation of an automatic document feeder in the case illustrated in FIGS. 16A and 16B;

FIG. 18 is a table summarizing the relationship between a second tilt and individual tilts derived from respective factors; and

FIG. 19 is a flowchart illustrating an image forming process.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming apparatus, a method, and a program according to embodiments of the present disclosure are described in detail below with reference to the accompanying drawings. The following describes an example in which the image forming apparatus is applied to a multifunction peripheral/product/printer (MFP). An automatic document feeder is an example of a “conveyance device”. The term “front” refers to a negative X-direction of the XYZ axes illustrated in the drawings, and the term “rear” refers to a positive X-direction thereof. The term “up” refers to a positive Z-direction, and the term “down” refers to a negative Z-direction. A clockwise direction is defined as a direction of rightward rotation about the Z-axis when viewed in the positive Z-direction. A counterclockwise direction is defined as a direction of leftward rotation about the Z-axis when viewed in the positive Z-direction.

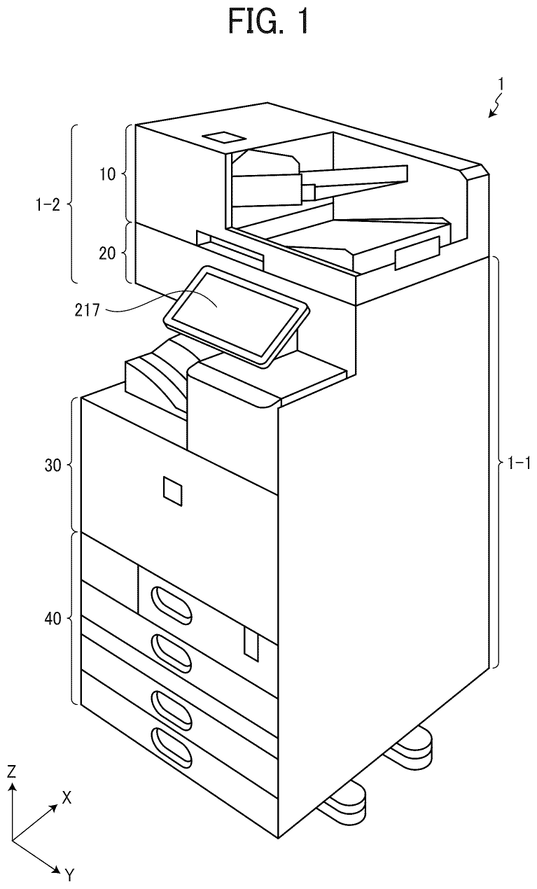

FIG. 1 is an external view of an image forming apparatus according to an embodiment of the present disclosure. As illustrated in FIG. 1, an image forming apparatus 1 is an image forming apparatus provided with an automatic document feeder 10 in an openable and closable manner. FIG. 1 illustrates the automatic document feeder 10 in a closed state. A main body 1-1 of the image forming apparatus 1 includes an image reading device 20, an image forming device 30, a sheet feeding device 40, and an operation panel 217.

The operation panel 217 includes a display screen and an input unit. The display screen displays an operation screen. The operation screen displays, for example, a current set value of the image forming apparatus 1.

The input unit receives a user input of a set value and a start instruction such as a scan start instruction or a copy start instruction. The input unit may be a hardware key, a software key displayed on the display screen, or both. The display screen may be provided with a touch panel to receive input operations performed on the display screen.

The operation panel 217 includes an application switching key, and the application switching key enables sequential switching and selection of a mode.

Examples of the mode include a “scan mode”, a “copy mode”, a “print mode”, and an “inspection mode”. Other modes such as a “document box mode” may also be provided. These modes may be referred to by different names depending on the model.

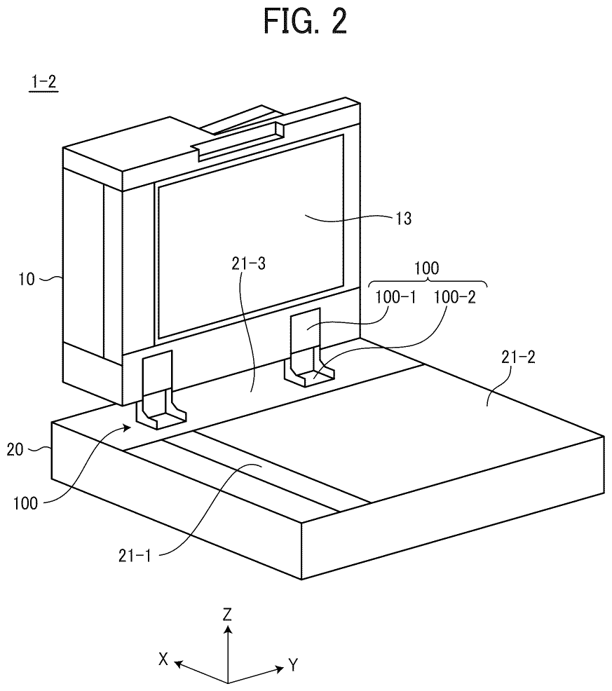

FIG. 2 is a schematic view of an image reader 1-2 of the image forming apparatus 1 illustrated in FIG. 1, illustrating an example of the automatic document feeder 10 and the image reading device 20. FIG. 2 illustrates the automatic document feeder 10 in an open state.

The automatic document feeder 10 is attached to the image reading device 20 at positions of two hinges 100 illustrated in FIG. 2. Each of the hinges 100 includes a hinge mechanism having a pair of flaps pivotable about a pivot shaft. Of the pair of flaps, a first flap 100-1 is attached to a housing frame of the automatic document feeder 10, and a second flap 100-2 is attached to a base 21-3 of the image reading device 20.

In the positions of the hinges 100 illustrated in FIG. 2, the automatic document feeder 10 is held in the open state in which a front portion thereof is positioned upward from the closed state. Lifting the front portion of the automatic document feeder 10 upward causes the first flap 100-1 of each of the hinges 100 attached on the rear side to pivot about the pivot shaft, thereby causing the automatic document feeder 10 to rise from the front side and stand upright.

In the present embodiment, the hinges 100 may be provided in any number and at any position, without being limited to the two positions illustrated in FIG. 2, provided that the automatic document feeder 10 can be opened and closed.

As illustrated in FIG. 2, the image reading device 20 includes a slit glass 21-1, a contact glass 21-2, and the base 21-3 on an upper surface thereof.

The slit glass 21-1 is provided for reading a document automatically conveyed by the automatic document feeder 10 in a sheet-through manner.

The contact glass 21-2 is provided for reading a document placed by a user in a flatbed manner.

The slit glass 21-1 is a slit member having a constant width, and the contact glass 21-2 has an area large enough to allow placement of an entire document.

The base 21-3 supports the automatic document feeder 10. The hinges 100 are attached at two locations on the base 21-3.

FIG. 2 illustrates a bottom surface of the automatic document feeder 10. The bottom surface of the automatic document feeder 10 is provided with a white member 13. The white member 13 prevents or reduces lifting of a document when the document is read in a flatbed manner, and also functions as a reference white portion for acquiring shading data.

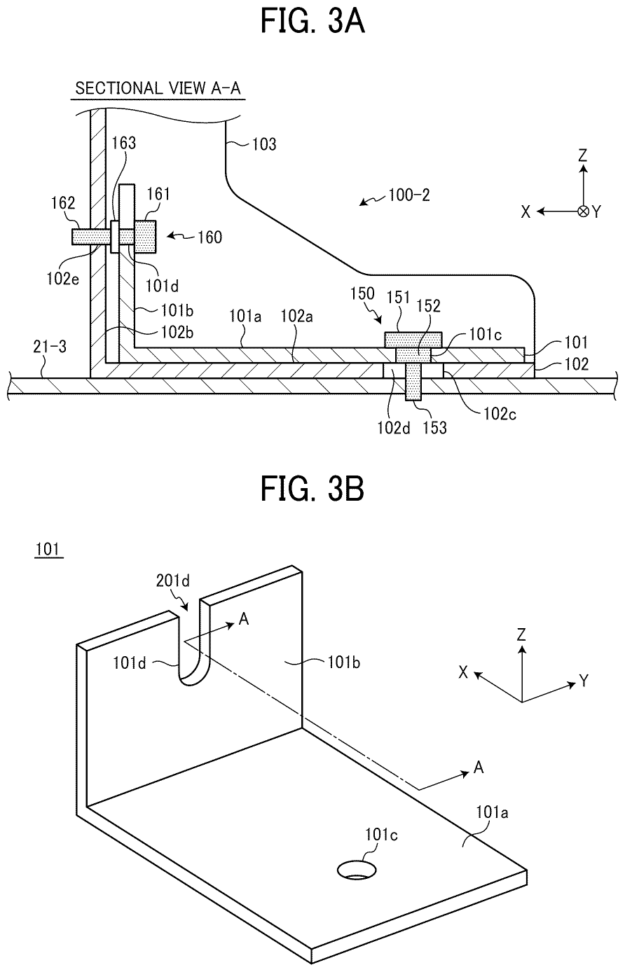

FIGS. 3A and 3B schematically illustrate an example of an adjustment unit provided for each of the hinges 100. In the present embodiment, the second flap 100-2 attached to the base 21-3 is provided with an adjustment mechanism as the adjustment unit.

FIG. 3A illustrates an example of a specific configuration of the adjustment mechanism. In FIG. 3A, the entire hinge mechanism is omitted to illustrate the adjustment mechanism in detail. For example, the first flap 100-1 attached to the automatic document feeder 10 and the pivot shaft that pivotably supports the first flap 100-1 and the second flap 100-2 are omitted.

In FIG. 3A, the arrangement of the components with respect to the XYZ axes is depicted to facilitate understanding of the positional relationship. Since the orientation of the second flap 100-2 is changeable in the XY plane, the arrangement of the second flap 100-2, once its orientation has been changed in the XY plane, differs from the arrangement with respect to the XY axes illustrated in FIG. 3A.

As illustrated in FIG. 3A, the second flap 100-2 is an L-shaped plate 102 and has ribs 103. The ribs 103 are provided on side surfaces of the L-shaped plate 102.

The L-shaped plate 102 is arranged in an orientation such that a surface of a first plate portion 102a of the L-shaped plate 102 is in contact with a surface of the base 21-3. A second plate portion 102b of the L-shaped plate 102 is perpendicular to the surface of the base 21-3.

The L-shaped plate 102 has an inner surface on which an L-shaped adjustment plate 101 having a shape corresponding to that of the L-shaped plate 102 is disposed. The L-shaped adjustment plate 101 is disposed in an orientation such that a surface of a third plate portion 101a, which is one plate portion of the L-shaped adjustment plate 101, is in contact with the surface of the first plate portion 102a and a surface of a fourth plate portion 101b, which is the other plate portion of the L-shaped adjustment plate 101, is parallel to the surface of the second plate portion 102b.

The L-shaped plate 102 and the adjustment plate 101 are fastened to the base 21-3 by a first screw 150 inserted through a first through hole 102c of the first plate portion 102a and a third through hole 101c of the third plate portion 101a and engaged with a female thread provided for the base 21-3.

In the present embodiment, a shoulder screw is used as an example of the first screw 150. The shoulder screw includes a screw head 151, a shoulder portion 152, and a threaded portion 153. The shoulder portion 152 has a diameter smaller than the diameter of the screw head 151 and larger than the diameter of the threaded portion 153. That is, the diameters decrease in the order of the screw head 151, the shoulder portion 152, and the threaded portion 153.

The third through hole 101c is a through hole having a size corresponding to the diameter of the shoulder portion 152 of the first screw 150.

The first through hole 102c is a laterally elongated hole having a width in the Y direction that is substantially equal to the diameter of the threaded portion 153 of the first screw 150 and a width in the X direction that is longer than the diameter of the threaded portion 153, as illustrated in FIG. 3A.

When the first screw 150 is tightened with the tip end of the threaded portion 153 of the first screw 150 fitting into the female thread provided for the base 21-3, the screw head 151 abuts the third plate portion 101a, ensuring that the shoulder portion 152 stays within the third through hole 101c. Further tightening of the first screw 150 causes the screw head 151 to press the third plate portion 101a, thereby fixing the L-shaped plate 102 to the base 21-3.

Since the first through hole 102c of the L-shaped plate 102 is laterally elongated, slight loosening of the first screw 150 allows the position of the L-shaped plate 102 to be adjusted in the X direction within a range of an X-direction clearance width 102d in the first through hole 102c. Specifically, the position of the L-shaped plate 102 can be adjusted in the X direction within a range defined by the width of the first through hole 102c in the X direction around the threaded portion 153 of the first screw 150.

Even when the first screw 150 is slightly loosened, the tip end of the threaded portion 153 remains engaged with the female thread on the base 21-3, keeping the position of the axis of the first screw 150 unchanged with respect to the base 21-3. Therefore, the orientation of the L-shaped plate 102 can also be changed integrally with the adjustment plate 101 around the axis of the first screw 150.

On the other hand, the fourth plate portion 101b of the adjustment plate 101 is fastened to the second plate portion 102b by a second screw 160 inserted through a fourth through hole 101d of the fourth plate portion 101b and a second through hole 102e of the second plate portion 102b. The second through hole 102e of the second plate portion 102b has an inner surface that functions as a female thread with which a threaded portion 162 of the second screw 160 is to be engaged.

FIG. 3B is a perspective view of the adjustment plate 101, illustrating an example of the adjustment plate 101. As illustrated in FIG. 3B, the fourth through hole 101d is an opening that is open at an edge 201d of the fourth plate portion 101b.

The fourth through hole 101d is a hole penetrating the fourth plate portion 101b in a thickness direction of the fourth plate portion 101b, and is formed in the fourth plate portion 101b so as to extend from a position at which the second screw 160 is screwed into the second through hole 102e of the second plate portion 102b to the edge 201d of the fourth plate portion 101b. In FIG. 3B, the fourth through hole 101d is a U-shaped hole having a width corresponding to the diameter of the threaded portion 162 of the second screw 160 and being open at the edge 201d.

The second screw 160 has a screw head 161 and the threaded portion 162. While a nut 163 is engaged with the threaded portion 162 at a predetermined distance from the screw head 161 of the second screw 160, a portion of the second screw 160 between the screw head 161 and the nut 163 is inserted into the fourth through hole 101d from the U-shaped opening side of the fourth through hole 101d. Further, the screw head 161 of the second screw 160 is turned at a position facing the second through hole 102e of the second plate portion 102b to screw the tip end of the threaded portion 162 of the second screw 160 such that the threaded portion 162 is engaged with a female thread of the second through hole 102e.

Tightening the first screw 150 fixes the L-shaped plate 102 and the adjustment plate 101 in position, whereas loosening the first screw 150 makes the L-shaped plate 102 movable along the X direction within the first through hole 102c.

Accordingly, turning the second screw 160 while the first screw 150 is loosened allows the L-shaped plate 102 to be moved in accordance with the turning direction of the second screw 160. For example, turning the second screw 160 clockwise allows the L-shaped plate 102 to move such that the second plate portion 102b of the L-shaped plate 102 approaches the fourth plate portion 101b of the adjustment plate 101. Turning the second screw 160 counterclockwise allows the L-shaped plate 102 to move such that the second plate portion 102b of the L-shaped plate 102 moves away from the fourth plate portion 101b of the adjustment plate 101.

The amount of movement of the L-shaped plate 102 can also be adjusted in accordance with an amount by which the second screw 160 is turned.

The second screw 160 is turned while the first screw 150 is slightly loosened to adjust the amount of movement of the L-shaped plate 102, and the orientation of the L-shaped plate 102 is changed integrally with the adjustment plate 101 around the axis of the first screw 150. Thereafter, the first screw 150 is tightened. As a result, the L-shaped plate 102 is fixed in position and orientation.

Adjusting the position and the orientation of the hinges 100 in the manner described above enables adjustment of the tilt of the automatic document feeder 10 with respect to the image reading device 20.

The adjustment mechanism using the adjustment plate 101 may be provided for one of the hinges 100 or may be provided for each of the two hinges 100.

In a case where the adjustment mechanism is provided for one of the hinges 100, the other hinge 100 (referred to as the second hinge) is configured to change its orientation with respect to the surface of the base 21-3.

For example, the first plate portion 102a of the second hinge is directly fixed to the base 21-3 by a screw. Loosening the screw allows the orientation of the second hinge to be adjusted in accordance with a change in the orientation of the hinge 100 provided with the adjustment mechanism, thereby enabling the orientation of the automatic document feeder 10 to be changed.

While an example has been described in which the adjustment mechanism is provided for each or one of the hinges 100, the adjustment mechanism is not limited to being provided for the hinge or hinges 100. Any other method for adjusting the orientation of the automatic document feeder 10 may be adopted.

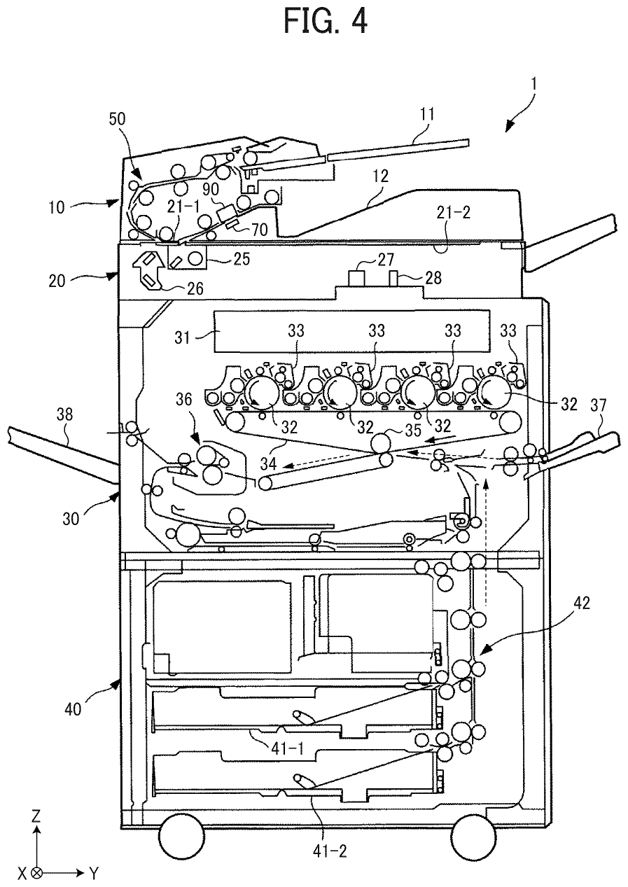

Internal components of the image forming apparatus 1 will be described with reference to FIGS. 4 to 6.

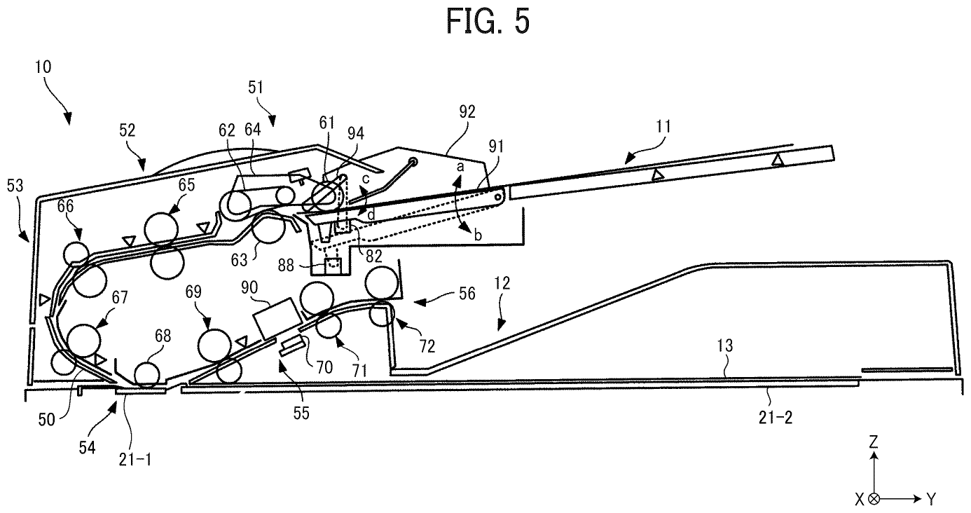

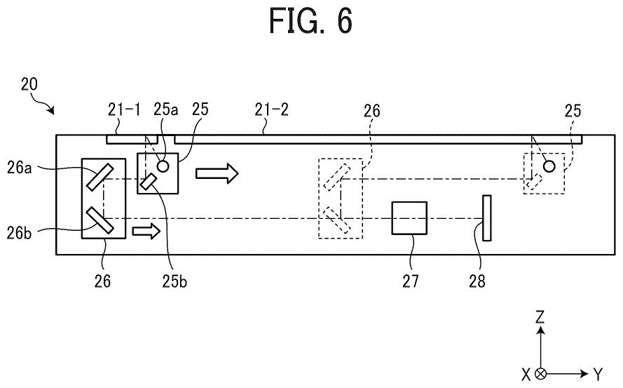

FIG. 4 is a schematic view of the internal components of the image forming apparatus 1. FIG. 5 is a detailed view of internal components of the automatic document feeder 10. FIG. 6 is a detailed view of internal components of the image reading device 20.

In FIG. 4, the automatic document feeder 10 includes an automatic document feeding mechanism that feeds a document from a document tray 11, conveys the fed document along a downward curved conveyance path 50, causes the image reading device 20 to read a front surface of the document at the position of the slit glass 21-1, thereafter causes a second reading unit 90 to read a back surface of the document, and ejects the document to an ejection tray 12.

The conveyance path 50 includes a conveyance mechanism provided with movable components such as rollers, idlers, or belts. The conveyance path 50, including the conveyance mechanism, is an example of a “conveyance unit” or a conveyor.

The above-described configuration of the automatic document feeder 10 is described below with reference to FIG. 5. As illustrated in FIG. 5, the automatic document feeder 10 includes the document tray 11 on which a document bundle is placed, a movable document table 91 that pivots in directions a and b in FIG. 5 about a base end portion thereof as a fulcrum, and a pair of side guide plates 92 that position the document bundle laterally relative to a feeding direction. Pivoting of the movable document table 91 adjusts the leading edge of the document bundle in the feeding direction to an appropriate height.

The document tray 11 is provided with a document width sensor and a document length sensor. The document width sensor is a sensor used by the automatic document feeder 10 to detect the document width of a document placed on the document tray 11. The document length sensor is a sensor used by the automatic document feeder 10 to detect the document length of a document placed on the document tray 11.

The document width sensor and the document length sensor may be each a reflective sensor that allows non-contact detection using an optical method or a contact-type actuator sensor.

The pair of side guide plates 92 is slidable in a document width direction. The pair of side guide plates 92 is provided, on the fixed side thereof, with a set feeler 94 that pivots upon document stacking.

A document set sensor 82 is provided at the lowest portion on the movement trajectory of the tip end of the set feeler 94 to allow the automatic document feeder 10 to detect stacking of a document on the document tray 11.

The automatic document feeder 10 detects stacking of a document on the document tray 11 based on whether the set feeler 94 has pivoted and moved away from the document set sensor 82. In response to the detection of document stacking, the automatic document feeder 10 drives the rollers, the idlers, the belts, or other components of the conveyance mechanism to automatically convey the document placed on the document tray 11 along the conveyance path 50.

The conveyance mechanism includes the following units, categorized by function, along the conveyance path 50: a separation and feeding unit 51; a pull-out unit 52; a turn unit 53; a first reading conveyance unit 54; a second reading conveyance unit 55; and an ejection unit 56.

The separation and feeding unit 51 is disposed near a feed port for feeding the document, and includes a pickup roller 61, a feed belt 62, and a reverse roller 63. The feed belt 62 and the reverse roller 63 are disposed such that the feed belt 62 and the reverse roller 63 face each other with the conveyance path 50 of the document interposed therebetween.

The pickup roller 61 is supported by a support arm member 64 attached to the feed belt 62, and is movable up and down in directions c and d in FIG. 5. The pickup roller 61 is driven by a cam mechanism to move up and down between a position at which the pickup roller 61 is out of contact with the document bundle and a position at which the pickup roller 61 is in contact with the document bundle. The document bundle includes one or more documents. At the contact position, the pickup roller 61 ideally picks up a single document from the top of the document bundle stacked on the document tray 11.

The feed belt 62 rotates in the feeding direction, and the reverse roller 63 rotates in a direction opposite to the feeding direction. When multiple documents are fed at a time (i.e., multi-feed of documents), the reverse roller 63 rotates in a direction opposite to the rotation direction of the feed belt 62. However, when the reverse roller 63 is in contact with the feed belt 62 or when a single document is being conveyed, the reverse roller 63 rotates together with the feed belt 62 by the action of a torque limiter. As a result, multi-feed of documents is prevented.

The pull-out unit 52 includes a pull-out roller pair 65. The pull-out roller pair 65 is a pair of rollers disposed with the conveyance path 50 of the document interposed therebetween. The pull-out unit 52 performs primary edge registration (so-called skew correction) of the fed document based on the drive timing of the pull-out roller pair 65 and the pickup roller 61, and pulls out and conveys the edge-aligned document.

The turn unit 53 is a section in which the conveyance path 50 is curved to flip the document over within the automatic document feeder 10, and includes an intermediate roller pair 66 and a reading entrance roller pair 67. The intermediate roller pair 66 and the reading entrance roller pair 67 are each a pair of rollers disposed with the conveyance path 50 interposed therebetween.

The intermediate roller pair 66 pulls out the document, turns the pulled out document as the document passes through the curved section, and sends the document to the reading entrance roller pair 67.

Then, the document with the front surface thereof facing down is advanced to a position of a first reading roller 68 under the timing control of the reading entrance roller pair 67.

The document conveyance speed from the pull-out unit 52 to the turn unit 53 is set higher than that in the first reading conveyance unit 54. This configuration reduces the time taken for the document to be conveyed to the first reading conveyance unit 54.

The first reading conveyance unit 54 includes the first reading roller 68. The first reading roller 68 is a roller disposed at a position facing the slit glass 21-1 of the image reading device 20. The first reading roller 68 conveys the fed document toward the second reading conveyance unit 55 while causing the surface (i.e., the front surface) of the fed document to contact the slit glass 21-1 in a gap between a roller surface of the first reading roller 68 and the slit glass 21-1. The surface (i.e., the front surface) of the document is scanned by the image reading device 20 in a sheet-through manner through the slit glass 21-1 while the document is conveyed in a conveyance direction.

In this case, the image reading device 20 scans the surface (i.e., the front surface) of the document with a first carriage and a second carriage kept stationary at a reading position of the slit glass 21-1, as described later.

The second reading conveyance unit 55 includes the second reading unit 90 and a background member 70. The second reading conveyance unit 55 further includes a pair of second reading entrance rollers 69 and a pair of second reading exit rollers 71 upstream and downstream of the second reading unit 90 and the background member 70 in the conveyance direction, respectively, to send the document to the downstream side in the conveyance direction.

The second reading unit 90 and the background member 70 are disposed so as to face each other with the conveyance path 50 interposed therebetween, and the second reading unit 90 reads the back surface of the document. The background member 70 serves to prevent or reduce lifting of the document in the second reading unit 90 and also serves as a reference white portion for acquiring shading data in the second reading unit 90. When double-sided reading is not performed, the document passes through the second reading unit 90 without being read.

The ejection unit 56 ejects the document to the ejection tray 12 by a pair of ejection rollers 72 provided near an ejection port.

In addition, the conveyance mechanism is provided with various sensors such as an abutment sensor, a document length sensor, a registration sensor, and an ejection sensor along the conveyance path 50, and the sensors are used for control.

A document width sensor is further provided between the pull-out roller pair 65 and the intermediate roller pair 66. The document length is also detectable from motor pulses by reading the leading edge and the trailing edge of the document by the abutment sensor or the registration sensor.

A configuration of the image reading device 20 is described below with reference to FIG. 6. As illustrated in FIG. 6, the slit glass 21-1 and the contact glass 21-2 are provided on the upper surface of the housing of the image reading device 20.

The slit glass 21-1 is used to read a document automatically conveyed to the reading position by the automatic document feeder 10 (see FIG. 5) in a sheet-through manner. At the reading position, the image reading device 20 irradiates the document conveyed in the conveyance direction with line light in a main scanning direction from below the slit glass 21-1, and reads the reflected light thereof. The slit glass 21-1 is a continuous slit member extending in the X direction and having a constant width in the Y direction.

The contact glass 21-2 is used to read the document in a flatbed manner. A user places a single document on the contact glass 21-2. The image reading device 20 reads the entire surface of the document by scanning the line light in the main scanning direction while moving in a sub-scanning direction with the document kept stationary. Accordingly, the contact glass 21-2 has a large area to accommodate the entire surface of the document.

In one example, the image reading device 20 according to the present embodiment includes a first carriage 25, a second carriage 26, an image forming lens 27, and an image sensor 28 inside the housing of the image reading device 20.

The first carriage 25 includes a light source 25a and a first mirror 25b.

The second carriage 26 includes a second mirror 26a and a third mirror 26b.

The first carriage 25 is configured to be reciprocally movable in the sub-scanning direction between a position indicated by a solid line and a position indicated by a dashed line in FIG. 6.

The second carriage 26 is also configured to be reciprocally movable in the sub-scanning direction between the position indicated by the solid line and the position indicated by the dashed line in FIG. 6.

In sheet-through reading, the document is read through the slit glass 21-1 with the first carriage 25 and the second carriage 26 kept stationary at the position indicated by the solid line.

That is, when the document is irradiated with light from the light source 25a through the first carriage 25 at the position indicated by the solid line, the light reflected from the surface of the document is reflected by the first mirror 25b, followed by the second mirror 26a and the third mirror 26b of the second carriage 26 at the position indicated by the solid line, and is incident on the image forming lens 27, and the image sensor 28 reads a light image of the document.

In flatbed reading, since the document is read while being positioned on the contact glass 21-2, the first carriage 25 and the second carriage 26 are moved in the sub-scanning direction, which is indicated by arrows, at a speed ratio of 2:1 to read the document. Thus, in flatbed reading, the first carriage 25 and the second carriage 26 are moved in the sub-scanning direction at a speed ratio of 2:1, thereby maintaining a constant optical path length of light from the document to the image forming lens 27, regardless of the movement of the first carriage 25 and the second carriage 26.

The image forming lens 27 includes a lens that focuses and forms an image of light from the mirror members onto the image sensor 28.

The image sensor 28 includes an imaging element such as a charge-coupled device (CCD) sensor. The image sensor 28 converts a light image formed on an imaging surface into an electrical signal by the imaging element and outputs image data of the document.

The image forming device 30 and the sheet feeding device 40 are described below with reference to FIG. 4.

The sheet feeding device 40 includes sheet feeding cassettes 41-1 and 41-2, and a sheet feeding mechanism 42 including various rollers that feed recording paper stored in the sheet feeding cassettes 41-1 and 41-2.

The sheet feeding cassettes 41-1 and 41-2 store recording paper having different paper sizes. The sheet feeding mechanism 42 sends recording paper fed from the sheet feeding cassette 41-1 or 41-2 in a direction indicated by a dotted arrow illustrated in FIG. 4.

The image forming device 30 includes an image forming unit. The image forming unit illustrated as an example in FIG. 4 is an electrophotographic image forming unit. As illustrated in FIG. 4, the image forming device 30 including the electrophotographic image forming unit includes an exposure unit 31, photoconductor drums 32, and components around the photoconductor drums 32, such as developing units 33. As an example, four photoconductor drums 32 are provided for four colors: cyan, yellow, magenta, and black.

Based on image data from, for example, the image reading device 20, the image forming device 30 forms latent images of the respective colors on the four photoconductor drums 32 using the exposure unit 31, and the developing units 33 of the respective colors supply toner of the corresponding colors to the latent images on the four photoconductor drums 32 to develop the latent images into toner images.

The image forming device 30 then rotates the photoconductor drums 32 to sequentially transfer the toner images on the respective photoconductor drums 32 onto a primary transfer belt 34 at primary transfer points where the respective photoconductor drums 32 meet the primary transfer belt 34. Further, the image forming device 30 drives the primary transfer belt 34 to move the toner images of the respective colors, which are superimposed on one another on the primary transfer belt 34, to a secondary transfer unit 35 for transfer onto the recording paper. Thereafter, the image forming device 30 sends the recording paper to a fixing unit 36 to fix the images, and then ejects the recording paper to a recording paper ejection tray 38.

The image forming device 30 further includes a manual feed tray 37 and a sheet feeding mechanism including idlers, rollers, or belts.

The sheet feeding mechanism sends the fed recording paper in a direction indicated by a dotted arrow illustrated in FIG. 4. On the recording paper, an image is formed at the secondary transfer unit 35.

In double-sided printing, the recording paper is sent from the fixing unit 36 toward a reversing unit and is reversed, and the reversed recording paper is sent to the secondary transfer unit 35.

The image forming unit is merely an example, and is not limited to an electrophotographic image forming unit. The image forming unit may be any other type of image forming unit such as an inkjet image forming unit, for example.

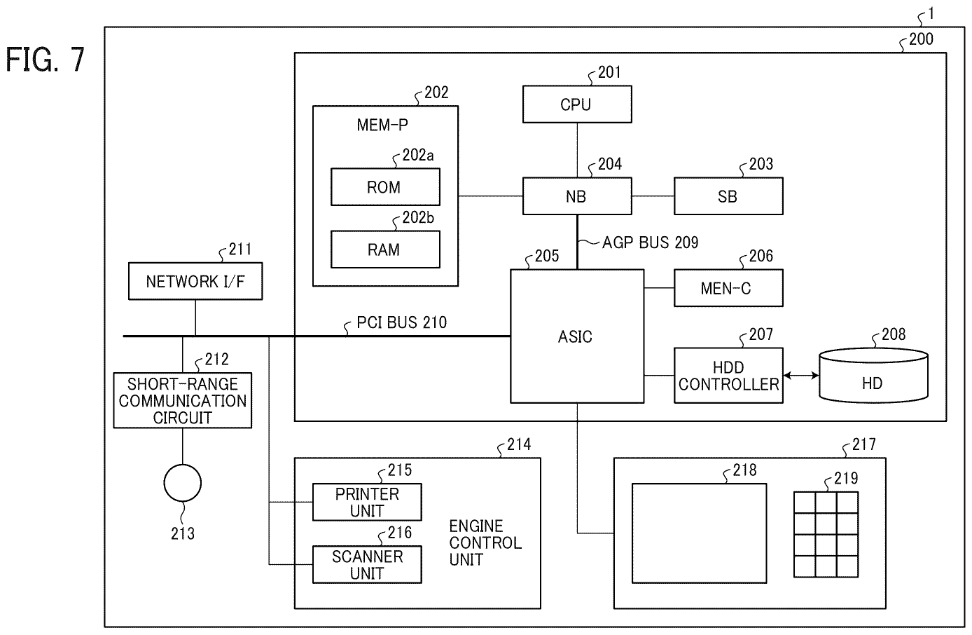

FIG. 7 is a schematic diagram of a hardware configuration of the image forming apparatus 1. As illustrated in FIG. 7, the image forming apparatus 1 includes a controller 200, a network interface (I/F) 211, a short-range communication circuit 212, an engine control unit 214, and the operation panel 217.

The controller 200 includes a central processing unit (CPU) 201, which is a computer processor, a system memory (MEM-P) 202, a south bridge (SB) 203, a north bridge (NB) 204, an application-specific integrated circuit (ASIC) 205, a local memory (MEM-C) 206, which is a storage unit, a hard disk drive (HDD) controller 207, and a hard disk (HD) 208, which is a storage unit. The NB 204 and the ASIC 205 are connected via an accelerated graphics port (AGP) bus 209.

The CPU 201, which is a processor, performs overall control of the image forming apparatus 1. The NB 204 is a bridge for connecting the CPU 201, the MEM-P 202, the SB 203, and the AGP bus 209. The NB 204 includes a memory controller that controls reading and writing to and from the MEM-P 202, a peripheral component interconnect (PCI) master, and an AGP target.

The MEM-P 202 includes a read-only memory (ROM) 202a as a memory that stores programs and data for implementing functions of the controller 200. The MEM-P 202 further includes a random-access memory (RAM) 202b as a memory that loads programs and data and a memory for storing drawing data for printing. The program stored in the RAM 202b may be configured to be provided in the form of an installable or executable format file recorded on a computer-readable recording medium, such as a compact disc-read-only memory (CD-ROM), a compact disc-recordable (CD-R), or a digital versatile disc (DVD).

The SB 203 is a bridge for connecting the NB 204 to a PCI device and a peripheral device. The ASIC 205 is an integrated circuit (IC) for image processing applications, and includes hardware elements for image processing. The ASIC 205 serves as a bridge that connects the AGP bus 209, a PCI bus 210, the HDD controller 207, and the MEM-C 206 to one another.

The ASIC 205 includes a PCI target, an AGP master, an arbiter (ARB) serving as a core of the ASIC 205, a memory controller that controls the MEM-C 206, multiple direct memory access controllers (DMACs) that perform processing such as rotation of image data by, for example, hardware logic, and a PCI unit that performs data transfer via the PCI bus 210 between a scanner unit 216 and a printer unit 215. The ASIC 205 may be connected to a Universal Serial Bus (USB) interface or an Institute of Electrical and Electronics Engineers (IEEE) 1394 interface.

The MEM-C 206 is a local memory used as a copy image buffer and a code buffer. The HD 208 is a storage for storing image data, storing font data used for printing, and storing forms. The HDD controller 207 controls reading and writing of data from and to the HD 208 under the control of the CPU 201. The AGP bus 209 is a bus interface for a graphics accelerator card, which has been proposed to accelerate graphics processing. The AGP bus 209 provides direct access to the MEM-P 202 with high throughput to increase the speed of the graphics accelerator card.

The short-range communication circuit 212 is provided with an antenna 213. The short-range communication circuit 212 is a communication circuit conforming to a standard such as near field communication (NFC) or Bluetooth®.

The engine control unit 214 includes the printer unit 215 and the scanner unit 216.

The printer unit 215 is an example of an image forming unit of the image forming device 30.

The scanner unit 216 is an example of a reading unit of the image reading device 20.

The printer unit 215 or the scanner unit 216 includes an image processing section that performs image processing such as error diffusion and gamma conversion.

The network I/F 211 is an interface for performing data communication using a communication network.

The short-range communication circuit 212 and the network I/F 211 are electrically connected to the ASIC 205 via the PCI bus 210.

The operation panel 217 includes a display screen 218 and an input unit 219.

The functions of the controller 200 of the image forming apparatus 1 are described below. In the image forming apparatus 1, when the CPU 201 executes a control program stored in the ROM 202a, the controller 200 implements the following functions.

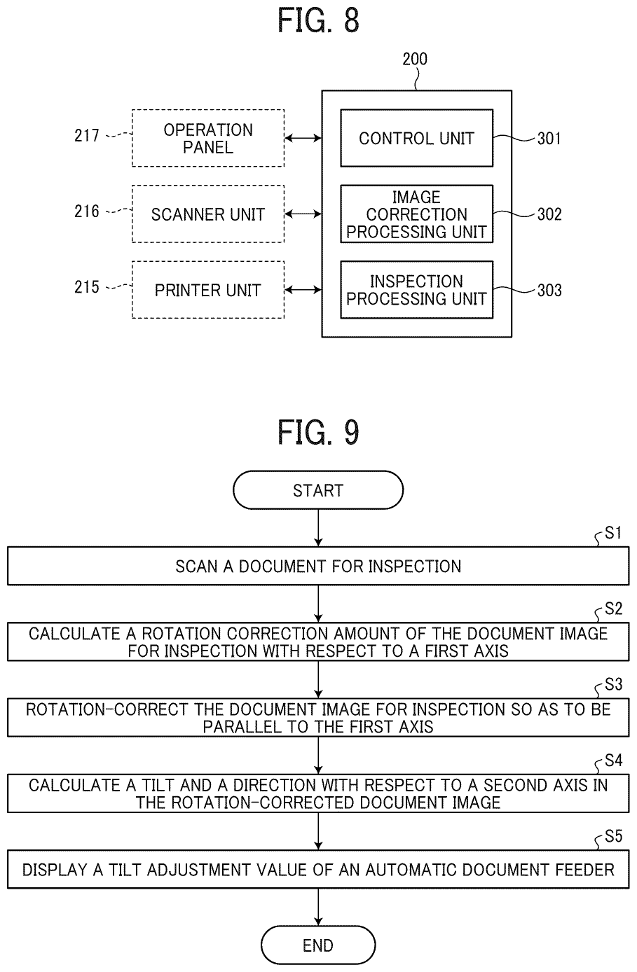

FIG. 8 is a schematic diagram illustrating a configuration of functional blocks of the controller 200. As illustrated in FIG. 8, the controller 200 functions as a control unit 301. In addition, the controller 200 implements functions such as an image correction processing unit 302 and an inspection processing unit 303.

The control unit 301 centrally controls the overall operation of the image forming apparatus 1. For example, the control unit 301 receives user inputs to configure settings or execute commands. Further, the control unit 301 outputs screen information to the operation panel 217 and updates the screen information.

In the “scan mode”, the control unit 301 controls the scanner unit 216. In response to receipt of a request for “scan execution” in the “scan mode”, the control unit 301 causes the scanner unit 216 to scan a document at the reading position on the image reading device 20.

In the present embodiment, the automatic document feeder 10 is provided. When no document is placed on the contact glass 21-2 of the image reading device 20, the automatic document feeder 10 is brought into the closed state and a document on the automatic document feeder 10 is scanned in a sheet-through manner. In other words, a document placed on the document tray 11 is fed by the automatic document feeder 10 to the reading position of the slit glass 21-1, and is then scanned by the scanner unit 216.

In the “copy mode”, the control unit 301 controls the scanner unit 216 and the printer unit 215. In response to receipt of a request for “copy execution” in the “copy mode”, the control unit 301 causes the scanner unit 216 to scan a document and the printer unit 215 to print a scanned image on recording paper. When no document is placed on the contact glass 21-2 of the image reading device 20, scanning is performed on a document on the automatic document feeder 10 in a sheet-through manner with the automatic document feeder 10 in the closed position, as described above.

In the “inspection mode”, the control unit 301 controls components under inspection. One inspection includes an inspection for adjusting the orientation of the automatic document feeder 10. In this inspection mode, in response to receipt of a request for “scan execution”, the control unit 301 controls the scanner unit 216. In this case, the automatic document feeder 10 is brought into the closed state, and a document on the automatic document feeder 10 is scanned in a sheet-through manner.

The image correction processing unit 302 performs image correction processing such as rotation correction on a document image, based on a scanned image acquired in the “scan mode” or the “copy mode”. The scanned image is two-dimensional image data of a two-dimensional plane, and includes the document image within a background image.

In the “inspection mode”, the inspection processing unit 303 calculates an adjustment value for adjusting the orientation of the automatic document feeder 10. Specifically, the inspection processing unit 303 acquires a scanned image, which is obtained by scanning a document for inspection on the automatic document feeder 10 in a sheet-through manner, and calculates, based on the scanned image, an adjustment value for adjusting the orientation of the automatic document feeder 10.

As described above, the control unit 301 centrally controls the overall operation of the image forming apparatus 1 in accordance with, for example, settings, mode switching, or execution of a command.

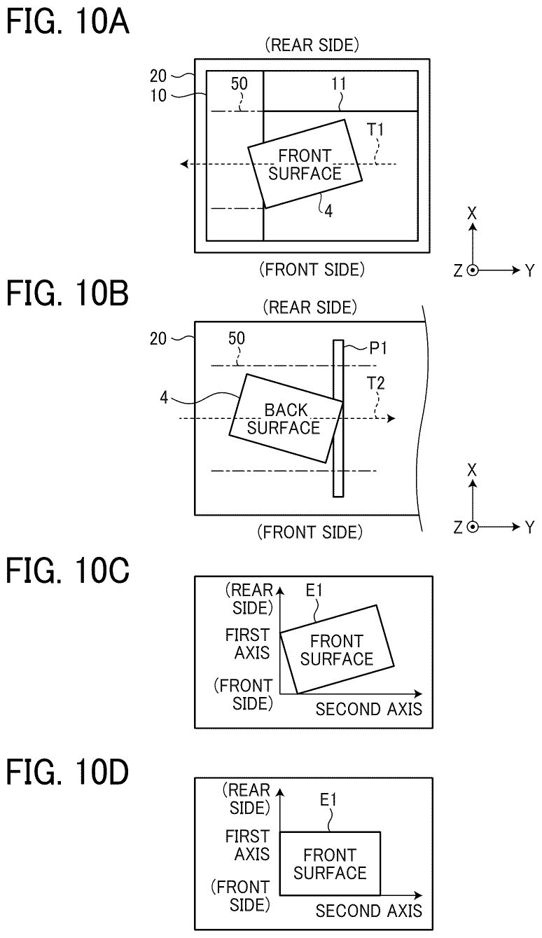

A method for an inspection process is described below with reference to FIG. 9. Details of the method for the inspection process will be described later with reference to FIGS. 10A to 18.

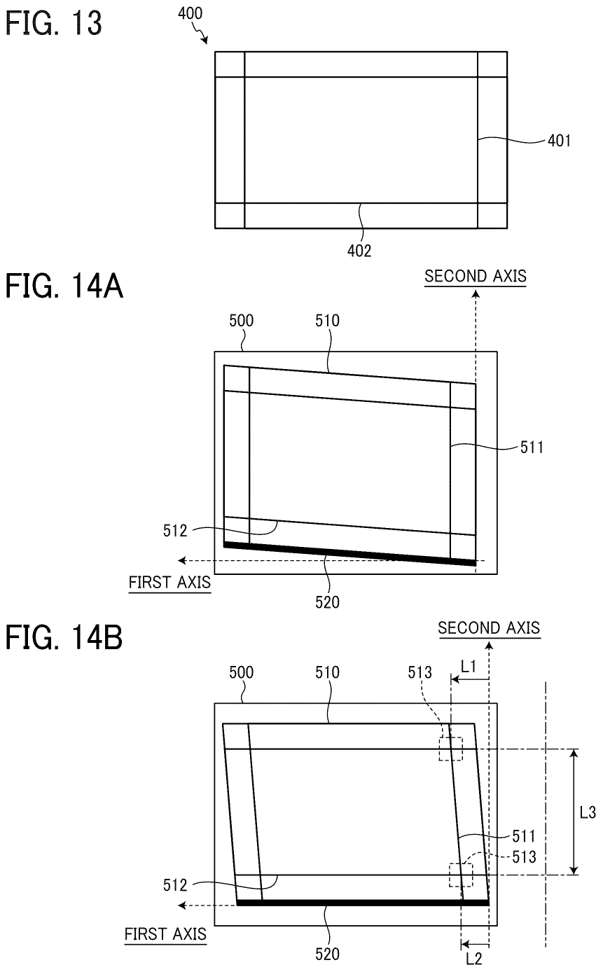

FIG. 9 is a flowchart illustrating an example of a method for an inspection process. In step S1, the controller 200 scans a document 400 (see FIG. 13) used for inspection in the “inspection mode”. In the following description, the document 400 may be referred to as an inspection document 400.

A user switches an operation mode of the controller 200 to the “inspection mode”, places the inspection document 400 on the document tray 11 of the automatic document feeder 10, and then presses a “Scan Start” key. Since the controller 200 is in the “inspection mode”, the controller 200 causes the scanner unit 216 to scan the inspection document 400 on the automatic document feeder 10 in a sheet-through manner, and acquires a scanned image of the inspection document 400.

Subsequently, in step S2, the controller 200 calculates, based on the scanned image of the inspection document 400, a rotation correction amount of a document image for inspection with respect to a first axis.

The controller 200 sets the first axis and a second axis for the scanned image of the inspection document 400 and calculates a rotation correction amount for correcting a tilt of the document image for inspection with respect to the first axis. The first axis is an axis corresponding to a line of light (main scanning line) emitted in the main scanning direction.

The second axis is an axis in a direction orthogonal to the first axis. The set first axis is synonymous with a “first set axis”. The set second axis is synonymous with a “second set axis”.

Subsequently, in step S3, the controller 200 performs rotation correction on the document image for inspection to align the document image for inspection parallel to the first axis.

Subsequently, in step S4, the controller 200 calculates a tilt and a tilt direction with respect to the second axis in the rotation-corrected document image for inspection.

Then, in step S5, the controller 200 displays a tilt adjustment value of the automatic document feeder 10 on the operation panel 217. For example, the controller 200 converts a calculation result of step S4 into a tilt adjustment value of the automatic document feeder 10, and displays the tilt adjustment value on a display screen of the operation panel 217.

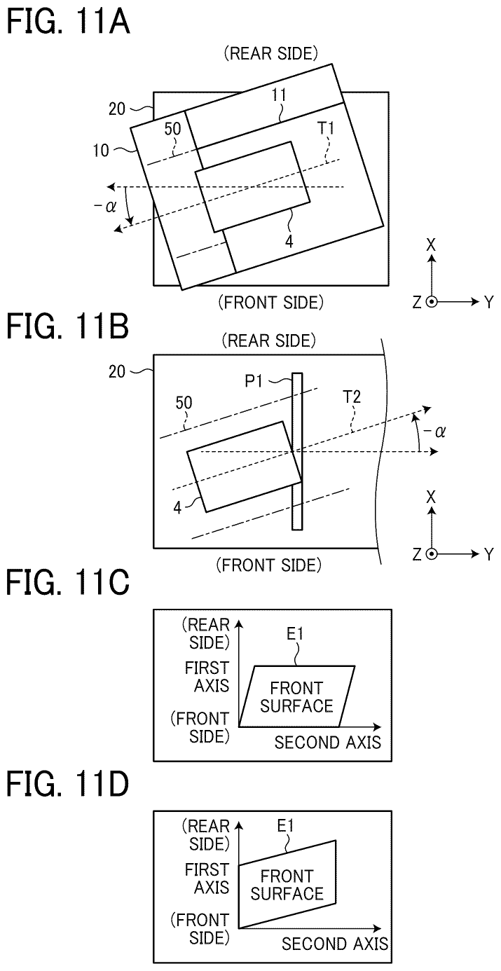

Subsequently, the method for the inspection process illustrated in FIG. 9 is described in more detail. FIGS. 10A to 10D and FIGS. 11A to 11D are comparison diagrams illustrating differences in state between document images. FIGS. 10A and 11A illustrate the positions of the document images on the automatic document feeder 10 side. FIGS. 10B and 11B illustrate the positions of the document images on the image reading device 20 side. FIGS. 10C and 11C illustrate the states of the document images in scanned images of documents read at the positions illustrated in FIGS. 10A and 10B and FIGS. 11A and 11B, respectively.

FIGS. 10A and 11A are plan views of the automatic document feeder 10 viewed from above. FIGS. 10B and 11B are also plan views of the image reading device 20 viewed in the same orientation as in FIGS. 10A and 11A, respectively.

Further, in FIGS. 10A and 11A, a document 4 is set on the automatic document feeder 10 with its front surface facing up. Since the automatic document feeder 10 according to an example of the present embodiment includes the turn unit 53, the front surface of the document 4 is flipped to face down at the reading position of the image reading device 20 illustrated in FIGS. 10B and 11B.

Consequently, a sheet feeding direction T1 and a conveyance direction T2 are opposite to each other.

In FIGS. 10C and 11C, the first axis and the second axis are set to illustrate the outline of the document image to clearly indicate the orientation and shape of the document image. On the first axis, the label “rear side” represents pixels passing through the “rear side” of the main scanning line, and the label “front side” represents pixels passing through the “front side” of the main scanning line.

FIGS. 10A, 10B, 10C, and 10D are schematic diagrams illustrating a tilt of a document image caused by a tilt of a document itself. Components other than the document 4 illustrated in FIGS. 10A and 10B are assumed to have no tilt.

As illustrated in FIG. 10A, when the document 4 itself is placed in a tilted manner on the document tray 11 or when the document 4 itself is fed in a tilted manner, the document 4 is sent in the sheet feeding direction T1 of the automatic document feeder 10 while remaining tilted, and the document 4 travels straight along the conveyance path 50 while remaining tilted.

Then, as illustrated in FIG. 10B, the document 4 is conveyed in the conveyance direction T2 across the reading position defined by the slit glass 21-1 of the image reading device 20. The document 4 is irradiated with light of a main scanning line P1 toward its front surface facing the surface of the slit glass 21-1, and the front surface of the document 4 is read line by line in the conveyance direction T2. The main scanning line P1 is orthogonal to the conveyance direction T2. In this manner, the document 4 advances to the reading position while remaining tilted, and passes through the reading position in a direction orthogonal to the main scanning line P1 while remaining tilted.

A document image E1 illustrated in FIG. 10C is a document image read in the manner described above. Since the conveyance direction T2 of the document 4 is orthogonal to the main scanning line P1, the shape of the document image E1 is preserved even if the document 4 is scanned in a tilted state. Furthermore, since the outline of the document 4 is rectangular, the outline of the document image E1 also remains rectangular.

FIG. 10D illustrates a rotation-corrected version of the document image E1 illustrated in FIG. 10C. Since the document image E1 is rectangular, performing rotation correction to rotate the document image E1 to match the first axis removes both the tilt with respect to the first axis and the tilt with respect to the second axis.

FIGS. 11A, 11B, 11C, and 11D are schematic diagrams illustrating a tilt of a document image caused by a tilt of the automatic document feeder 10 itself. The internal components of the automatic document feeder 10 and the image reading device 20 illustrated in FIGS. 11A and 11B are assumed to have no tilt.

As illustrated in FIG. 11A, since the automatic document feeder 10 itself is tilted, the sheet feeding direction T1 is also tilted in the same direction. The document 4 is sent in the sheet feeding direction T1 of the automatic document feeder 10 and travels straight along the conveyance path 50.

In this case, as illustrated in FIG. 11B, the conveyance direction T2 is also tilted at the reading position. Accordingly, the conveyance direction T2 of the document 4 is not orthogonal to the main scanning line P1, and the document 4 crosses the main scanning line P1 in an oblique direction as illustrated in FIG. 11B.

As illustrated in FIG. 11B, when the document 4, which is rectangular, crosses the main scanning line P1 in an oblique direction, the leading edge of the document 4 in the conveyance direction T2 passes across the main scanning line P1 while being tilted with respect to the main scanning line P1. Both side edges of the rectangular document 4 pass through the same respective positions on the main scanning line P1 as the rectangular document 4 travels through the main scanning line P1.

A document image E1 illustrated in FIG. 11C is a document image read in the manner described above. As illustrated in FIG. 11C, the document image E1 is a parallelogram that is tilted with respect to the first axis but remains aligned with the second axis.

FIG. 11D illustrates a rotation-corrected version of the document image E1 illustrated in FIG. 11C. As illustrated in FIG. 11D, performing rotation correction to rotate the document image E1 to match the first axis removes the tilt with respect to the first axis. The present embodiment detects a tilt of the parallelogram with respect to the second axis, which is produced by removing the tilt with respect to the first axis, and uses the detected tilt as an adjustment value.

As described above, the document image results in a parallelogram shape due to the tilt of the automatic document feeder 10 itself. There are other cases where the document image results in a parallelogram shape. For example, the document image results in a parallelogram shape also in the following two cases.

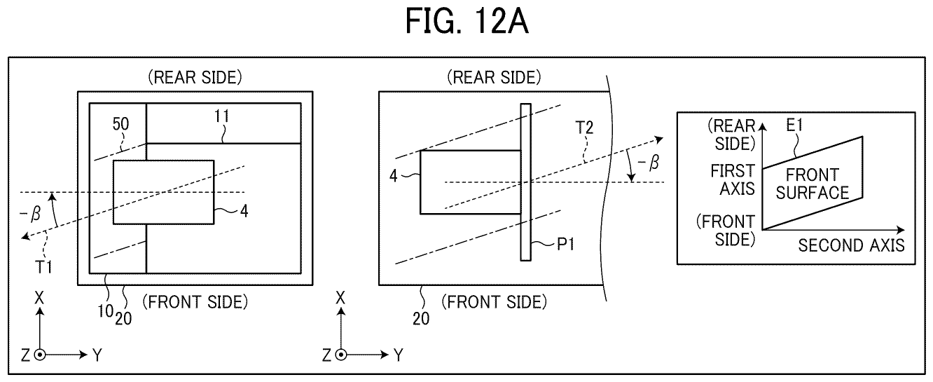

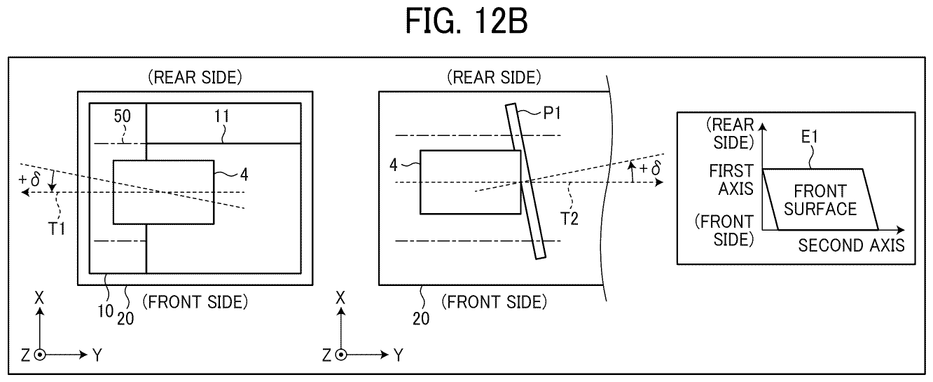

FIGS. 12A and 12B are schematic diagrams illustrating two other cases in which a document image results in a parallelogram shape.

FIG. 12A illustrates a case where the conveyance mechanism included in the automatic document feeder 10 has a tilted conveyance direction. In the automatic document feeder 10, for example, component variation or assembly variation causes a tilt of the conveyance mechanism. The automatic document feeder 10 itself and the image reading device 20 are assumed to have no tilt.

As illustrated in FIG. 12A, the conveyance path 50 of the document 4 is tilted due to the tilt of the conveyance mechanism. In this case, as illustrated in FIG. 12A, the document 4 travels straight along a tilted path extending in the sheet feeding direction T1.

Since the conveyance path 50 is tilted, the conveyance path 50 also remains tilted at the reading position of the image reading device 20. Thus, at the reading position of the image reading device 20, the conveyance direction T2 is consistent with the tilted orientation of the conveyance path 50.

Also in this case, since the conveyance direction T2 of the document 4 is not orthogonal to the main scanning line P1, the document 4 crosses the main scanning line P1 in an oblique direction. However, the rectangular document 4 crosses obliquely while the leading edge thereof remains parallel to the main scanning line P1 in the conveyance direction T2. Consequently, each side edge of the document 4 passes through different positions on the main scanning line P1. For this reason, the document image E1 results in a parallelogram shape tilted with respect to the second axis.

FIG. 12B illustrates a case where the main scanning line P1 is tilted. In the image reading device 20, for example, component variation or assembly variation causes a tilt of the reading unit, and the main scanning line P1 is tilted. The automatic document feeder 10 and the image reading device 20 are assumed to have no tilt.

As illustrated in FIG. 12B, the document 4, which travels straight along the conveyance path 50 in the sheet feeding direction T1, passes through the main scanning line P1 in the conveyance direction T2 at the reading position of the image reading device 20. In this case, due to the tilt of the main scanning line P1, the main scanning line P1 is oriented at an angle relative to the conveyance direction T2 at the reading position. Thus, also in this case, the document 4 crosses the main scanning line P1 in an oblique direction.

Also in this case, as illustrated in FIG. 12B, the leading edge of the rectangular document 4 in the conveyance direction T2 passes across the main scanning line P1 while being oriented at an angle relative to the main scanning line P1. Both side edges of the rectangular document 4 pass through the same respective positions on the main scanning line P1 as the rectangular document 4 travels through the main scanning line P1. FIG. 11B also illustrates how the document 4 passes through the main scanning line P1. In the present case, unlike FIG. 11B, the leading edge of the document 4 is tilted toward the orientation as illustrated in FIG. 12B.

From FIGS. 10A to 10D, FIGS. 11A to 11D, and FIGS. 12A and 12B, it can be concluded that the tilt of edges of the document image E1 is caused by four factors corresponding to the above four cases. The factors that cause the document image to result in a parallelogram shape are categorized into three types corresponding to the three cases illustrated in FIGS. 11A to 11D and FIGS. 12A and 12B.

In a case where the document image results in a parallelogram shape, when rotation correction is performed to rotate the document image to match the first axis, a tilt with respect to the second axis is detected. This tilt is the sum of the tilt components derived from the three types of factors that cause the document image to result in a parallelogram shape illustrated in FIGS. 11A to 11D and FIGS. 12A and 12B. In the following description, the tilt with respect to the second axis may be referred to as a “second tilt”.

In the present embodiment, taking these three types of factors into consideration, the second tilt is calculated from the document image as below, and the calculated value is used to adjust the orientation of the automatic document feeder 10.

FIGS. 11A to 11D and FIGS. 12A and 12B illustrate tilts α, β, and δ. The tilts α, β, and δ are tilt components derived from the above-described three types of factors that cause the document image to result in a parallelogram shape. These tilt components will be described in detail below with reference to FIG. 18, and the description thereof is omitted here.

FIG. 13 is a diagram illustrating an example of a document used for inspection. As illustrated in FIG. 13, the inspection document 400, which is a document used for inspection, has a rectangular shape, and is provided with parallel lines 401 along the leading and trailing edges thereof and parallel lines 402 along the side edges thereof. The intersections of the respective parallel lines 401 and 402 serve as reference marks. The parallel lines 401 and 402 are merely an example, and only the reference marks may be provided.

The inspection document 400 is a document image used for inspection in the inspection mode. The inspection document 400 is placed on the document tray 11 of the automatic document feeder 10 and is scanned by the image reading device 20. Based on the scanned image, the second tilt is calculated.

FIGS. 14A and 14B are schematic diagrams illustrating an example of a scanned image obtained by scanning the inspection document 400. The scanned image is two-dimensional image data of a two-dimensional plane. FIG. 14A illustrates the scanned image of the document image for inspection before rotation correction, and FIG. 14B illustrates the scanned image of the rotation-corrected document image for inspection.

A scanned image 500 depicts an example of the outline of a document image for inspection in a case where the rectangular inspection document 400 is read as a parallelogram. Parallel lines 511 and 512 depicted along the outline of the document image for inspection are lines obtained by reading the parallel lines 401 and 402 provided in the inspection document 400, respectively.

As illustrated in FIG. 14A, the document image for inspection before rotation correction has an outline such that a leading edge 520 and a trailing edge 510 are both tilted with respect to the first axis and the side edges are parallel to the second axis. The leading edge 520 is an example of a first edge, and one of the side edges having a tilt different from that of the leading edge 520 is an example of a second edge.

The inspection processing unit 303 detects the leading edge 520 of the document image for inspection from the scanned image 500 illustrated in FIG. 14A. As an example, the inspection processing unit 303 detects the leading edge 520 of the document image for inspection by, for example, linearly approximating a pixel row in a shadow of the leading edge 520 illustrated in FIG. 14A.

Furthermore, the inspection processing unit 303 rotates the entire document image for inspection to align the leading edge 520, which is detected by linear approximation, parallel to the first axis, resulting in an orientation illustrated in FIG. 14B.

Then, the inspection processing unit 303 calculates the second tilt of the rotation-corrected document image for inspection illustrated in FIG. 14B. Specifically, the inspection processing unit 303 calculates the tilt of one of the side edges of the document image for inspection with respect to the second axis.

The second tilt is calculated by detecting two reference marks 513 illustrated in FIG. 14B. The two reference marks 513 are intersection marks corresponding to the intersections of the respective parallel lines 401 and 402 illustrated in FIG. 13.

The inspection processing unit 303 first calculates the distance between the second axis and the reference mark 513 near the trailing edge of the rotation-corrected document image for inspection illustrated in FIG. 14B and the distance between the second axis and the reference mark 513 near the leading edge thereof. The distance between the second axis and the reference mark 513 near the trailing edge is defined as a first distance L1, and the distance between the second axis and the reference mark 513 near the leading edge is defined as a second distance L2.

When the first distance L1 and the second distance L2 are equal to each other, the inspection processing unit 303 determines that the document image for inspection has a rectangular shape, and then ends the inspection process. In the case of a rectangular shape determination, the tilt of the document itself is a factor. This tilt can be addressed by performing rotation correction on the scanned image 500, and the orientation of the automatic document feeder 10 is not adjusted. Thus, the inspection processing unit 303 ends the inspection process.

When the first distance L1 and the second distance L2 are different from each other, the inspection processing unit 303 determines that the document image for inspection has a parallelogram shape. In this determination, the orientation of the automatic document feeder 10 is adjusted. Accordingly, the inspection processing unit 303 calculates the second tilt of one of the side edges of the document image for inspection with respect to the second axis as below.

As an example, a value obtained by subtracting the second distance L2 from the first distance L1 and the distance (a third distance L3) between the two reference marks 513 along the second axis are used to calculate a tilt θ2 in accordance with Equation (1) as follows.

θ2=(L1−L2)/K×L3 (1)

In Equation (1), K is a constant. As an example, the constant K is set to 200 mm (i.e., K=200 mm) to mitigate variation in results caused by differences in document size.

The controller 200 outputs, to a screen on the operation panel 217, the value of the tilt θ2, which is obtained by the inspection processing unit 303 using Expression (1), or an adjustment value corresponding to the value of the tilt θ2.

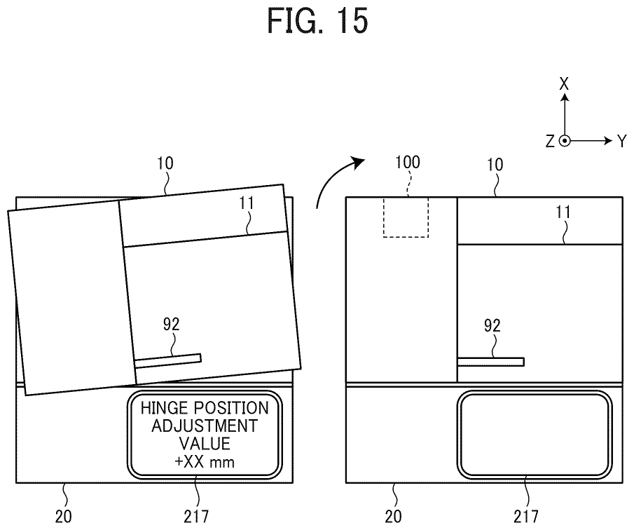

FIG. 15 is a schematic diagram illustrating an adjustment direction of the orientation of the automatic document feeder 10 in the example illustrated in FIGS. 14A and 14B. FIG. 15 illustrates, side by side, top plan views of the automatic document feeder 10 before and after adjustment.

As illustrated in FIG. 15, based on adjustment information displayed on the operation panel 217, a user adjusts the orientation of the automatic document feeder 10 in a clockwise direction by using the adjustment unit.

The adjustment information displayed on the operation panel 217 indicates an adjustment value of the adjustment unit. The adjustment information indicates an adjustment value for one of the two hinges 100 or respective adjustment values for the two hinges 100.

The example illustrated in FIG. 15 represents an adjustment value for one hinge 100. In this case, adjustment is performed by loosening the first screws 150 of both the hinges 100 and turning the second screw 160 of the one hinge 100 based on the adjustment value (+XX mm), where “XX” represents numerical information. The adjustment value “+XX mm” is used for adjusting the orientation of the automatic document feeder 10 in the clockwise direction.

Turning the second screw 160 allows the one hinge 100 to change its orientation in the clockwise direction while changing its position in the positive or negative X-direction by an amount corresponding to the adjustment value, and allows the other hinge 100 to change its orientation in the clockwise direction with its position unchanged. Consequently, the orientation of the automatic document feeder 10 can be adjusted clockwise.

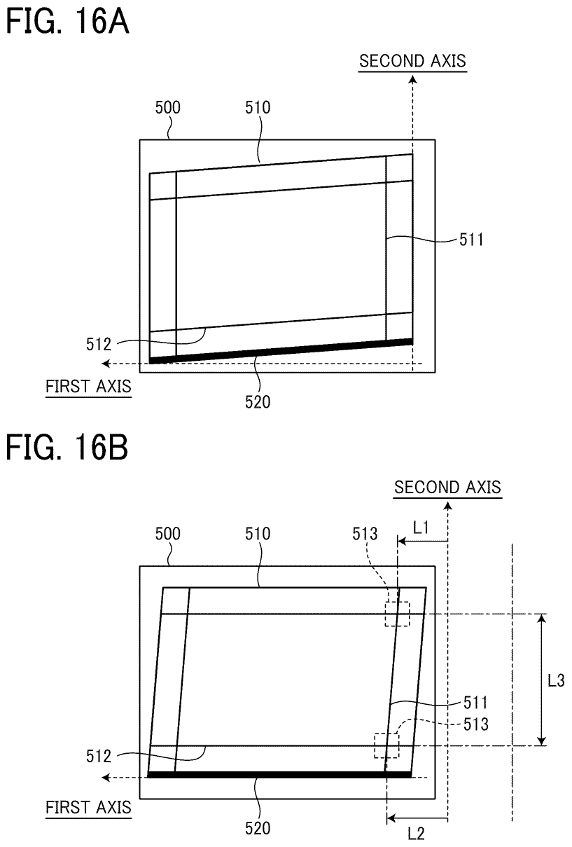

FIGS. 16A and 16B are schematic diagrams illustrating an example of a counterclockwise rotation of a document image. As illustrated in FIGS. 16A and 16B, the document image for inspection is tilted counterclockwise, namely, in a direction opposite to the tilt of the document image for inspection illustrated in FIGS. 14A and 14B. Other than this, the configuration is similar to that in FIGS. 14A and 14B. Also in this case, the second tilt can be calculated using a similar method. Further description is omitted to avoid repetition.

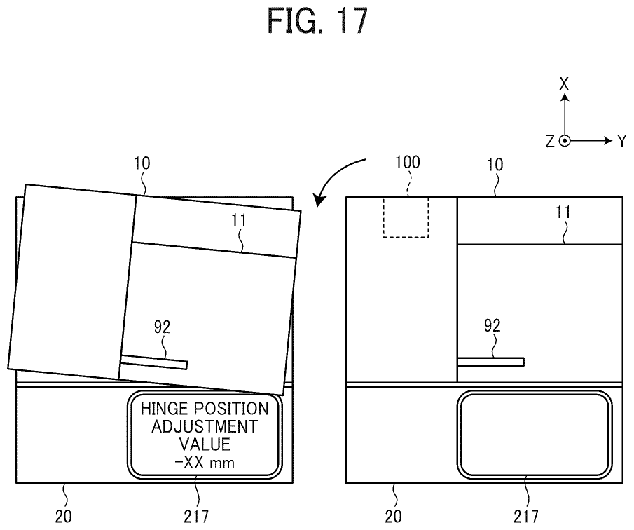

FIG. 17 is a schematic diagram illustrating an adjustment direction of the orientation of the automatic document feeder 10 in the example illustrated in FIGS. 16A and 16B. FIG. 17 illustrates, side by side, top plan views of the automatic document feeder 10 before and after adjustment, like FIG. 15.

In this case, a negative adjustment value (−XX mm) is displayed on the operation panel 217. Thus, in this case, based on the adjustment value (−XX mm), the user adjusts the orientation of the automatic document feeder 10 in a counterclockwise direction by using the adjustment unit.

The directions of the tilts of the document images for inspection illustrated in FIGS. 14A and 16A are merely examples. The calculation method described above can calculate an adjustment value (i.e., the tilt θ2) for adjusting an overall tilt derived from the respective tilt components of the three factors illustrated in FIGS. 11A to 11D and FIGS. 12A and 12B.

Relationship between Each Tilt Component and Second Tilt

In the foregoing description, the second tilt is the sum of the tilt components derived from the three types of factors illustrated in FIGS. 11A to 11D and FIGS. 12A and 12B.

FIG. 18 is a table summarizing the relationship between the second tilt and individual tilts derived from respective factors. Tilts α, β, and δ illustrated in FIG. 18 respectively correspond to the tilts α, β, and δ illustrated in FIGS. 11A to 11D and FIGS. 12A and 12B. In the automatic document feeder 10 illustrated in FIGS. 11A to 11D and FIGS. 12A and 12B, a tilt component corresponding to a case in which the orientation of the automatic document feeder 10 is changed in a clockwise direction to make the conveyance direction T2 orthogonal to the orientation of the main scanning line P1 is indicated as a negative (−) component. A tilt component corresponding to a case in which the orientation of the automatic document feeder 10 is changed in a counterclockwise direction to make the conveyance direction T2 orthogonal to the orientation of the main scanning line P1 is indicated as a positive (+) component.

In the calculation table illustrated in FIG. 18, in the “before adjustment” field, the tilt α is caused by the tilt of the automatic document feeder 10 itself (see FIGS. 11A, 11B, 11C, and 11D). In this case, edges of the document image are tilted with respect to the first axis (see FIG. 11C). The edges of the document image are tilted at an angle α with respect to the first axis, and tilting the edges of the document image by −α removes only the tilt with respect to the first axis. Thus, in the calculation table, the value in the “first axis” column under the “before adjustment” field is set to “−α”.

In the calculation table illustrated in FIG. 18, in the “before adjustment” field, the tilt β is caused by the tilt of the conveyance direction of the conveyance mechanism included in the automatic document feeder 10 (see FIG. 12A). In this case, edges of the document image are tilted with respect to the second axis. The edges of the document image are tilted at an angle β with respect to the second axis, and tilting the edges of the document image by −β removes only the tilt with respect to the second axis. Thus, in the calculation table, the value in the “second axis” column under the “before adjustment” field is set to “−β”.

In the calculation table illustrated in FIG. 18, in the “before adjustment” field, the tilt δ is caused by the tilt of the main scanning line P1 (see FIG. 12B). In this case, edges of the document image are tilted with respect to the first axis. The edges of the document image are tilted at an angle δ with respect to the first axis, and in this case, tilting the edges of the document image by +δ removes only the tilt with respect to the first axis. Thus, in the calculation table, the value in the “first axis” column under the “before adjustment” field is set to “+δ”.

In the calculation table illustrated in FIG. 18, in the “before adjustment” field, the tilt γ is caused by the tilt of the document 4 itself (see FIGS. 10A, 10B, 10C, and 10D). In this case, edges of the document image are tilted at the same angle with respect to both the first axis and the second axis. When the edges of the document image are tilted at an angle γ with respect to the first axis, in this case, tilting the edges of the document image by +γ removes the tilt with respect to both the first axis and the second axis. Thus, in the calculation table, the values in the “first axis” and “second axis” columns under the “before adjustment” field are both set to “+γ”.

In the calculation table illustrated in FIG. 18, the “before adjustment” field contains values of the tilt θ of the document image. The “first axis” column contains a value indicating the tilt of the document image with respect to the first axis, and the “second axis” column contains a value indicating the tilt of the document image with respect to the second axis. The value in the “first axis” column is set to the value “−α+γ+δ”, which is the sum of the values of the respective tilts (i.e., the parameters α, β, δ, and γ) in the “first axis” column, and the value in the “second axis” column is set to the value “γ−β”, which is the sum of the values of the respective tilts (i.e., the parameters α, β, δ, and γ) in the “second axis” column.

In the calculation table illustrated in FIG. 18, the “before adjustment” field contains a value of the tilt θ1 by which rotation correction is performed with respect to the first axis. This value is set to “α−(γ+δ)”, which cancels out the value “−α+γ+δ” in the “first axis” column for the tilt θ to “0”. The same value is set in the “first axis” and “second axis” columns.

In the calculation table illustrated in FIG. 18, the “before adjustment” field contains values of the tilt θ2 of a document image on which rotation correction has been performed for the first axis. The “first axis” column contains a value indicating the tilt of the document image on which rotation correction has been performed for the first axis with respect to the first axis, and the “second axis” column contains a value indicating the tilt of the document image on which rotation correction has been performed for the first axis with respect to the second axis. Specifically, the “first axis” column contains the value “0”, which is the sum of the value “−α+γ+δ” in the “first axis” column for the tilt θ and the value “α−(γ+δ)” in the “first axis” column for the tilt θ1. The “second axis” column contains the value “α−(β+δ)”, which is the sum of the value “γ−β” in the “second axis” column for the tilt θ and the value “α−(γ+δ)” in the “second axis” column for the tilt θ1.

The value “α−(β+δ)” indicates the tilt of edges of the document image on which rotation correction has been performed for the first axis with respect to the second axis. In other words, the value “α−(β+δ)” corresponds to the second tilt. In the present embodiment, the value “α−(β+δ)” to which the three parameters α, β, and δ are related is used as an adjustment value for adjusting the tilt of the automatic document feeder 10.

In the table illustrated in FIG. 18, the “after adjustment” field contains values of the respective tilts obtained after the tilt of the automatic document feeder 10 has been adjusted based on the adjustment value “α−(β+δ)” indicated in the calculation table of the “before adjustment” field. In other words, the calculation table of the “before adjustment” field is a table summarizing tilts of a document image of a document to be read after the adjustment.

Adjustment of the tilt of the automatic document feeder 10 corresponds to adjustment of the tilt α. Thus, the value in the “first axis” column under the “after adjustment” field for the tilt α is calculated using the value “−α” and the adjustment value “α−(β+δ)” under the “before adjustment” field. Specifically, the calculation result of −{α−{α−(β+δ)}}, which results in “−(β+δ)”, is set as the value.

The tilts β, δ, and γ, which are factors independent of the tilt α, remain at the respective values indicated under the “before adjustment” field even after the tilt of the automatic document feeder 10 has been adjusted.

Under the “after adjustment” field, the value in the “first axis” column for the tilt θ is set to the value “γ1 −β”, which is the sum of the values of the respective parameters in the “first axis” column, and the value in the “second axis” column for the tilt θ is set to the value “γ1 −β”, which is the sum of the values of the respective parameters in the “second axis” column. The value under the “after adjustment” field for the tilt θ1 is set to “−(γ1 −β)”.

Thus, the value in the “first axis” column under the “after adjustment” field for the tilt θ2 is set to “0”, which is the sum of the value “γ1 −β” in the “first axis” column for the tilt θ and the value “−(γ1 −β)” in the “first axis” column for the tilt θ1. The value in the “second axis” column is also set to “0”.

Since the value of the tilt θ2 is set to “0” in both the “first axis” column and the “second axis” column, this indicates that the parallelogram distortion has been corrected.

Since the tilt of the automatic document feeder 10 has been adjusted, the document image output by reading a new document will be rectangular.

Furthermore, since the tilt of each new document itself varies, the “after adjustment” field of the table contains a tilt “γ1” corresponding to the tilt γ in the “before adjustment” field, indicating that the tilt varies for each document.

After the adjustment, the document image output by reading a new document is rectangular. Thus, performing rotation correction to align the edges of the document image parallel to the first axis brings both the tilt “γ1” of the document image with respect to the first axis and the tilt “γ1” of the document image with respect to the second axis to “0”, which indicates that precise adjustment has been performed.

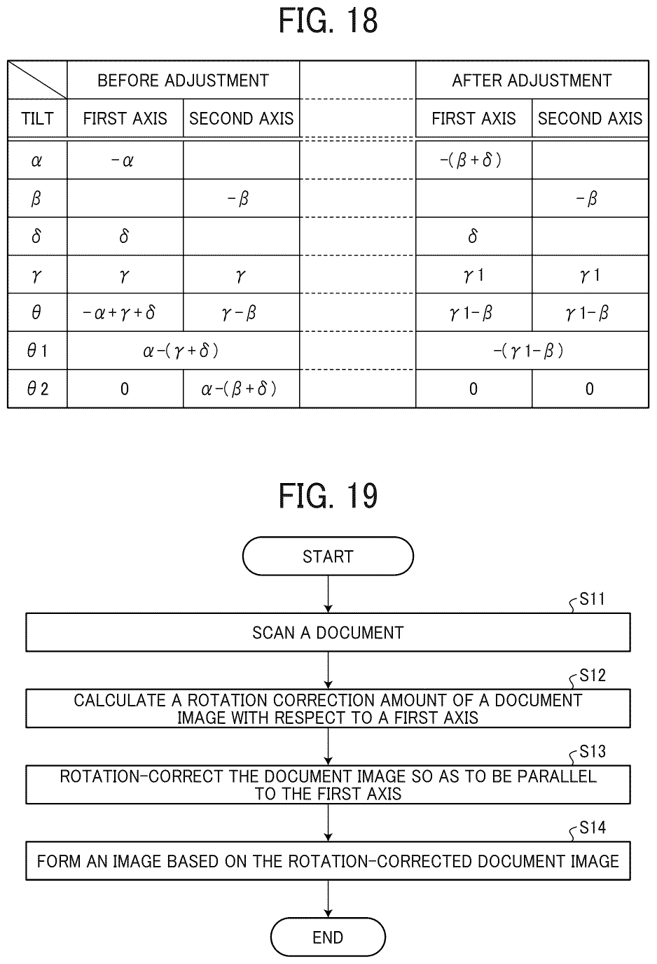

A processing flow of an image forming process is described below with reference to FIG. 19. FIG. 19 is a flowchart illustrating an example of an image forming process.

First, in step S11, the controller 200 scans a document in the “copy mode”. A user switches the operation mode of the controller 200 to the “copy mode”, places a document on, for example, the document tray 11 of the automatic document feeder 10, and presses a “Copy Start” key. The scan is performed by the scanner unit 216. The document may be a normal document instead of a document for inspection.

Through the processing of step S11, the controller 200 causes the scanner unit 216 to read the document placed on the automatic document feeder 10 or the contact glass 21-2, and acquires a scanned image from the scanner unit 216.

Then, in step S12, the controller 200 calculates, based on the scanned image of the document, a rotation correction amount of a document image with respect to the first axis.

Subsequently, in step S13, the controller 200 performs rotation correction on the document image to align the document image parallel to the first axis.

Then, in step S14, the controller 200 forms an image based on the rotation-corrected document image. For example, the controller 200 transmits the rotation-corrected document image to the printer unit 215, and causes the printer unit 215 to perform processing for forming an image on recording paper.

In the present embodiment, by way of example but not limitation, the image reading device 20 adjusts a tilt of the automatic document feeder 10. The automatic document feeder 10 may be provided with an adjustment unit (e.g., an adjustment mechanism) for adjusting a tilt of the image reading device 20. That is, any adjustment unit (or adjustment mechanism) that allows adjustment of a tilt of the image reading device 20 or the automatic document feeder 10 may be used.

Furthermore, while an example has been described in which the adjustment mechanism is provided for each or one of the hinges 100, the adjustment mechanism is not limited to being provided for the hinge or hinges 100. Any member having the functions of the adjustment unit (or adjustment mechanism) that enables adjustment of a tilt of the image reading device 20 or the automatic document feeder 10 may be implemented in a form other than the hinges 100.

As described above, there are four factors that cause the tilt of edges of a document image, and these factors include displacement at the time of assembly or installation of components in the conveyance unit within the automatic document feeder 10 or the reading unit within the image reading device 20. For this reason, whether the automatic document feeder 10 is oriented appropriately with respect to the image reading device 20 is difficult to determine only from appearance and adjust. It is also difficult to precisely adjust a tilt of the automatic document feeder 10 only based on a tilt of edges of the document image with respect to the first axis.

In contrast, in the present embodiment, by calculating a tilt of the second edge of the document image with respect to the second axis after rotating the document image to align the edges thereof with the first axis, an accurate adjustment value can be obtained. Thus, a precise adjustment of the tilt of the automatic document feeder 10 can be performed.

A program executed by the image forming apparatus according to the embodiment and modifications thereof is provided in the form of an installable or executable format file recorded on a computer-readable recording medium, such as a CD-ROM, a flexible disk (FD), a CD-R, or a DVD.

The program executed by the image forming apparatus according to the embodiment and modifications thereof may be configured to be stored in a computer connected to a network such as the Internet and provided by being downloaded via the network. The program executed by the image forming apparatus according to the embodiment and modifications thereof may be configured to be provided or distributed via a network such as the Internet.

The program executed by the image forming apparatus according to the embodiment and modifications thereof may be configured to be provided by being incorporated in advance in a ROM or the like.

Each of the functions in the embodiment described above may be implemented by one or more pieces of processing circuitry. As used herein, the term “processing circuitry” is used to include processors programmed to implement each function by software, such as a processor implemented by an electronic circuit, and devices designed to implement the functions described above, such as an ASIC, a digital signal processor (DSP), a field-programmable gate array (FPGA), and existing circuit modules.

A program executed by the image forming apparatus according to the present embodiment is provided by being incorporated in advance in a ROM or the like.

The program executed by the image forming apparatus according to the present embodiment may be configured to be provided in the form of an installable or executable format file recorded on a computer-readable recording medium, such as a CD-ROM, an FD, a CD-R, or a DVD.

Furthermore, the program executed by the image forming apparatus according to the present embodiment may be configured to be stored in a computer connected to a network such as the Internet and provided by being downloaded via the network. The program executed by the image forming apparatus according to the present embodiment may be configured to be provided or distributed via a network such as the Internet.

The program executed by the image forming apparatus according to the present embodiment has a module configuration including the above-described units, such as a control unit, a rotation correction processing unit, and an inspection processing unit. In actual hardware, a CPU (or processor) reads the program from the ROM and executes the program, whereby the above-described units are loaded onto a main storage device and the control unit, the rotation correction processing unit, and the inspection processing unit are generated on the main storage device.

In the embodiment, an example has been described in which the image processing apparatus according to an embodiment of the present disclosure is applied to an MFP. However, the image processing apparatus may be implemented as any image processing apparatus such as a copying machine, a printer, a scanner apparatus, or a facsimile apparatus.

Each of the functions in the embodiments described above may be implemented by one or more pieces of processing circuitry. As used herein, the term “processing circuitry” is used to include processors programmed to implement each function by software, such as a processor implemented by an electronic circuit, and devices designed to implement the functions described above, such as an ASIC, a DSP, an FPGA, and existing circuit modules.

While embodiments of the present disclosure have been described above, the above-described embodiments are presented as examples, and are not intended to limit the scope of the present disclosure. The novel embodiments may be implemented in a variety of other forms, and various combinations, omissions, substitutions, and changes may be made without departing from the gist and scope of the disclosure. These novel embodiments and modifications thereof are included in the scope and gist of the disclosure, and are included in the disclosure described in the claims and equivalents thereof. Furthermore, constituent elements across different embodiments and modifications may be combined as appropriate.

According to an embodiment of the present disclosure, it is possible to obtain accurate adjustment information.

An image forming apparatus includes a conveyor, a reader, circuitry, an adjuster, and an image former. The conveyor conveys a document to a reading position in a conveyance direction. The reader reads the document, at the reading position, in a scanning direction parallel to a first axis and orthogonal to the conveyance direction to output a two-dimensional image data including a first document image having a first edge. The circuitry rotates the first document image to align the first edge, being tilted at a first tilt relative to a first axis, to be parallel with the first axis to generate a second document image having a second edge, being tilted at a second tilt, different from the first tilt, relative to a second axis orthogonal to the first axis; and output adjustment information including the second tilt relative to the second axis. The adjustor adjusts an orientation of the conveyor or the reader, based on the adjustment information. The image former forms an image based on the second document image.

The circuitry is configured to detect the first edge from a shadow of a leading edge, in the conveying direction, of the first document image in the two-dimensional image data; and rotate the first document image to align the first edge with the first axis.

The circuitry is configured to detect a reference mark from the second document image; and calculate the second tilt of the second edge relative to the second axis.

The circuitry performs an inspection mode to output the adjustment information.

The image forming apparatus further includes a conveyance device including the conveyor. The adjustor adjusts a tilt between the conveyance direction and the scanning direction. The tilt is based on a combination of a tilt (α) of the conveyance device itself; a tilt (β) of the orientation of the conveyor in the conveyance device; and a tilt (γ) of the orientation of the reader in the scanning direction.

The circuitry is configured to output the adjustment information including multiple parameters causing the second tilt of the second edge relative to the second axis.

The image forming apparatus further includes a hinge connecting the reader and the conveyor on the reader. The conveyer is rotated about the hinge to openably close the reader. The adjuster is disposed at the hinge.

A method includes conveying a document to a reading position in a conveyance direction; reading the document, at the reading position, in a scanning direction parallel to a first axis and orthogonal to the conveyance direction to output a two-dimensional image data including a first document image having a first edge; rotating the first document image to align the first edge, being tilted at a first tilt relative to a first axis, to be parallel with the first axis to generate a second document image having a second edge, being tilted at a second tilt, different from the first tilt, relative to a second axis orthogonal to the first axis; outputting adjustment information including the second tilt relative to the second axis; adjusting an orientation of the conveyor or the reader, based on the adjustment information; and forming an image based on the second document image.

A non-transitory recording medium storing a plurality of instructions which, when executed by one or more processors, causes the one or more processors to perform a method including conveying a document to a reading position in a conveyance direction; reading the document, at the reading position, in a scanning direction parallel to a first axis and orthogonal to the conveyance direction to output a two-dimensional image data including a first document image having a first edge; rotating the first document image to align the first edge, being tilted at a first tilt relative to a first axis, to be parallel with the first axis to generate a second document image having a second edge, being tilted at a second tilt, different from the first tilt, relative to a second axis orthogonal to the first axis; outputting adjustment information including the second tilt relative to the second axis; adjusting an orientation of the conveyor or the reader, based on the adjustment information; and forming an image based on the second document image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a conveyor to convey a document to a reading position in a conveyance direction;
a reader to:
read the document, at the reading position, in a scanning direction parallel to a first axis and orthogonal to the conveyance direction to output a two-dimensional image data including:
a first document image having a first edge;
circuitry configured to:
rotate the first document image to align the first edge, being tilted at a first tilt relative to a first axis, to be parallel with the first axis to generate:
a second document image having a second edge, being tilted at a second tilt, different from the first tilt, relative to a second axis orthogonal to the first axis;
output adjustment information including the second tilt relative to the second axis;
an adjustor to adjust an orientation of the conveyor or the reader, based on the adjustment information; and
an image former to form an image based on the second document image.

2. The image forming apparatus according to claim 1, wherein
the circuitry is configured to:
detect the first edge from a shadow of a leading edge, in the conveying direction, of the first document image in the two-dimensional image data; and
rotate the first document image to align the first edge with the first axis.

3. The image forming apparatus according to claim 1, wherein
the circuitry is configured to:
detect a reference mark from the second document image; and
calculate the second tilt of the second edge relative to the second axis.

4. The image forming apparatus according to claim 1, wherein
the circuitry performs an inspection mode to output the adjustment information.

5. The image forming apparatus according to claim 1, further comprising a conveyance device including the conveyor, wherein
the adjustor adjusts a tilt between the conveyance direction and the scanning direction, and
the tilt is based on a combination of:
a tilt (α) of the conveyance device itself;
a tilt (β) of the orientation of the conveyor in the conveyance device; and
a tilt (γ) of the orientation of the reader in the scanning direction.

6. The image forming apparatus according to claim 1, wherein
the circuitry is configured to output the adjustment information including multiple parameters causing the second tilt of the second edge relative to the second axis.

7. The image forming apparatus according to claim 1, further comprising:
a hinge connecting the reader and the conveyor on the reader,
wherein the conveyer is rotated about the hinge to openably close the reader and
the adjuster is disposed at the hinge.

8. A method comprising:
conveying a document to a reading position in a conveyance direction by a conveyor;
reading the document by a reader, at the reading position, in a scanning direction parallel to a first axis and orthogonal to the conveyance direction to output a two-dimensional image data including:
a first document image having a first edge;
rotating the first document image to align the first edge, being tilted at a first tilt relative to a first axis, to be parallel with the first axis to generate:
a second document image having a second edge, being tilted at a second tilt, different from the first tilt, relative to a second axis orthogonal to the first axis;
outputting adjustment information including the second tilt relative to the second axis;
adjusting an orientation of the conveyor or the reader, based on the adjustment information; and
forming an image based on the second document image.

9. A non-transitory recording medium storing a plurality of instructions which, when executed by one or more processors, causes the one or more processors to perform a method comprising:
conveying a document to a reading position in a conveyance direction by a conveyor;
reading the document by a reader, at the reading position, in a scanning direction parallel to a first axis and orthogonal to the conveyance direction to output a two-dimensional image data including:
a first document image having a first edge;
rotating the first document image to align the first edge, being tilted at a first tilt relative to a first axis, to be parallel with the first axis to generate:
a second document image having a second edge, being tilted at a second tilt, different from the first tilt, relative to a second axis orthogonal to the first axis;
outputting adjustment information including the second tilt relative to the second axis;
adjusting an orientation of the conveyor or the reader, based on the adjustment information; and
forming an image based on the second document image.
